(19) United States
(12) Patent Application Publication
(10) Pub. No.: US 2007/0100478 A1
(43) Pub. Date: May 3, 2007

(54) METHOD AND SYSTEM FOR TESTING A CONTROL SYSTEM FOR A MARINE PETROLEUM PROCESS PLANT

(75) Inventors: Olav EGELAND, Trondheim (NO); Tor Arne JOHANSEN, Vikhamar (NO); Asgeir Johan Sorensen, Trondheim (NO); Roger Skjetne, Trondheim (NO)

Correspondence Address: ROTHWELL, FIGG, ERNST & MANBECK, P.C., 1425 K STREET, N.W., SUITE 800, WASHINGTON, DC, 20005, US

(73) Assignee: MARINE CYBERNETICS AS, Tiller (NO)

(21) Appl. No.: 11/553,670

(22) Filed: Oct. 27, 2006

(30) Foreign Application Priority Data
Oct. 31, 2005 (NO) 20055085

(51) Int. Cl. G05B 13/02

(52) U.S. Cl. 700/45

(57) ABSTRACT

A system for testing whether a control system (2) is capable of detection and handling of faults, failures or failure modes (8) in a petroleum process plant (1), said control system (2) arranged for being
connected with input signal lines (30) for receiving sensor and other input signals (30) from said petroleum process plant (1), and
connected with control signals lines (40) for transmitting control signals (4) to said petroleum process plant (1), comprising the following features
said control system (2) arranged for receiving simulated sensor signals or other input signals (3s) from a simulated petroleum process plant (10) over said input signal line (30),
said control system (2) arranged for transmitting control signals (4) to said petroleum process plant simulator (10) over said control signal line (40), The novel and inventive of the invention comprises the following features:
an input signal modifier (9) arranged for being connected to said input signal line (30),
said input signal modifier (9) arranged for modifying one or more said input signals (3) into modified input signals (13),
said input signal modifier (9) being arranged for transmitting one or more of said modified input signals (13) and remaining non-modified input signals (3) to said control system (2).

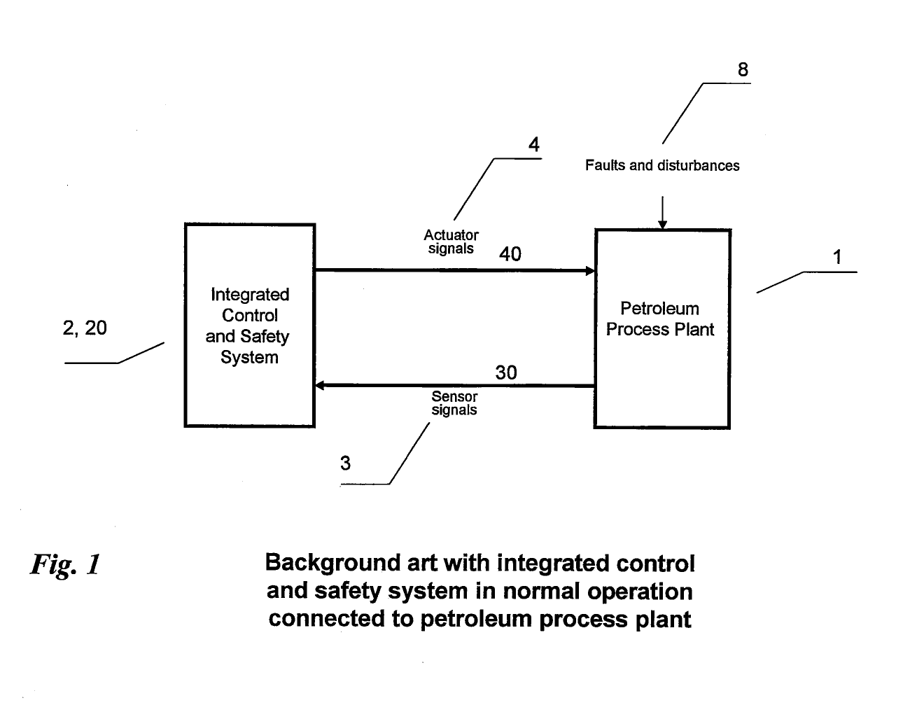

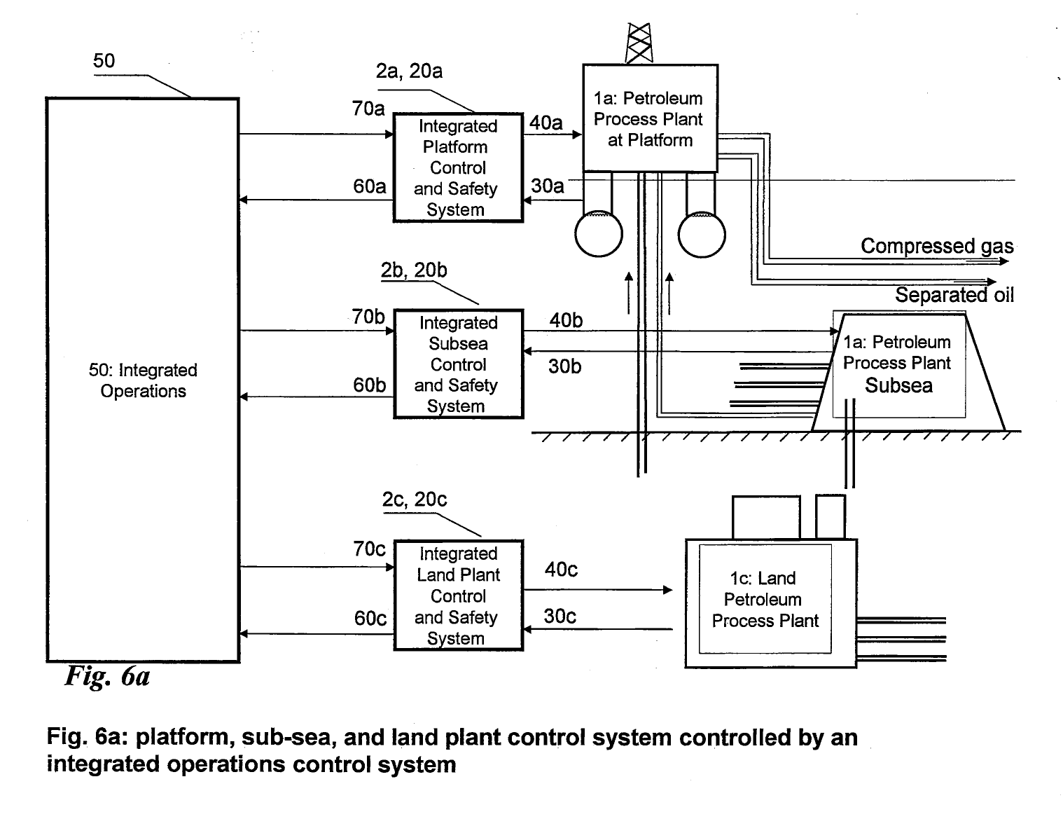

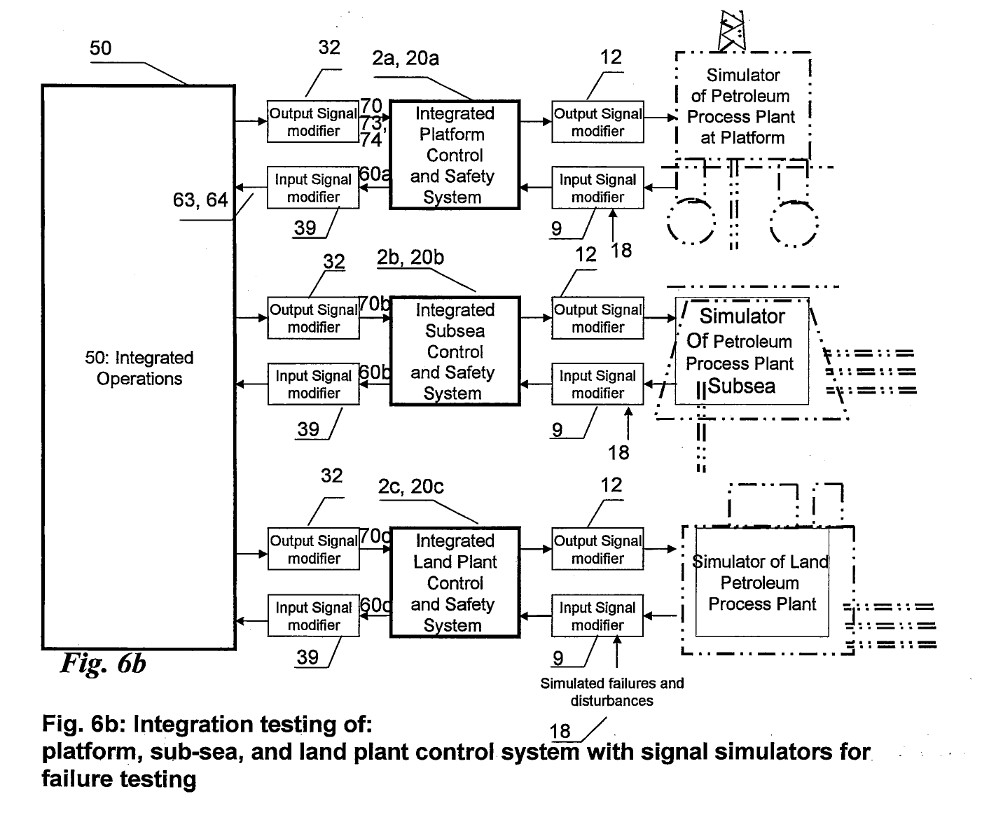

The present invention pertains to the testing of control systems for offshore petroleum process plants, such as a plant illustrated in FIG. 1. The petroleum process plant may be situated on a fixed or floating production platform, a separate process platform, or be arranged as a subsea petroleum process plant, and may include an onshore petroleum process plant. A combined system having both a production platform with a petroleum process plant, a subsea production process plant, and a land petroleum production process plant, all of whom may be controlled by separate control systems, is illustrated in FIG. 6a. The petroleum processing plant as used in this patent specification comprises receiving produced petroleum fluid from a well, usually under pressure and high temperature, separating it into water, oil, gas and sand, cooling said oil, flaring off parts of said gas, compressing parts of said gas, production of LNG for export or storing, electrical energy production or reinjection, purifying produced water and sand for dumping or reinjection, and exporting or storing said oil.

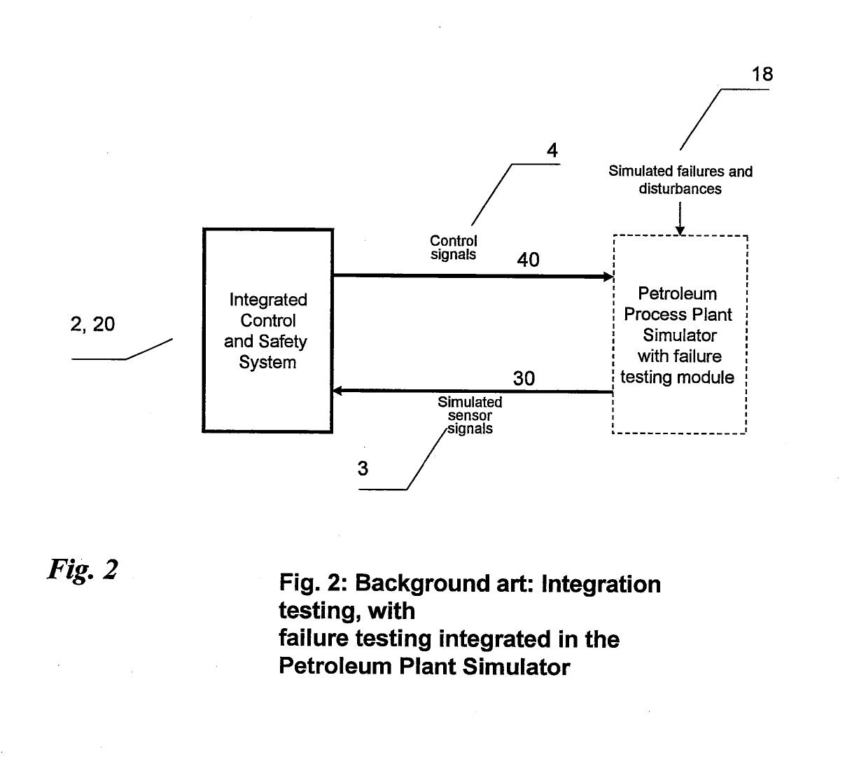

Due to the limited and very expensive space on board a production platform or in a subsea production plant module, processing will be conducted on a minimum level in order to separate the products for export via pipeline or shipping, and should rather not include cracking, refining or production of different oil products like gasoline, diesel, heavy oil, etc. Process plants used in the production and processing of oil and gas from an oil or gas well are controlled by complex integrated control systems that have a large number of input signals from sensors, and a large number of outputs in the form of actuator commands. Such integrated control systems will typically comprise several control systems and safety systems that are operated in a tightly integrated manner. The successful operation of the integrated control system will depend on the software on the control systems. Software or signal errors may cause poor performance leading to inefficient operation of the plant, undesired shut-downs, or failure to conduct emergency shut-down which may lead to damage to the plant and to the environment. To ensure that the control and safety systems function appropriately, it is imperative that the control and safety systems are thoroughly tested before and during installation of the integrated control system. Such testing is usually done with simulators. This is done in unit testing in which an individual control system is tested by connecting it to a simulator in a configuration that may be referred to as Hardware-In-the-Loop (HIL) testing. The simulator is arranged to simulate the process to be controlled by the control system, as illustrated in FIG. 2. In the same way, integration testing of control systems with simulators is known in which several or all of the control systems and safety systems are integrated and connected to a simulator. Simulators used in the testing of integrated control systems will often be self-contained systems that represent the dynamics of the petroleum process plant accurately by calculating the output signals that will result from given input signals. However, such simulators will usually not allow for the introduction of detailed failure situations in the petroleum plant, e.g. associated with failure in a sensor, signal transmission errors of breakdown in an actuator, due to the fact that the simulator may be proprietary and provided in a compiled or in otherwise non-open software state. This is a problem because the most difficult and error-prone part of an integrated control system is the handling and detection of failure situations. Furthermore, there are various situations in which several different simulators are interconnected in a network, and in which the different simulators are made by different vendors, and in which there is no possibility of testing interaction effects between the different simulators. Although some failures may be simulated for each separate simulation module, there is little or no possibility of testing the system as a whole for errors. The simulators are also usually delivered in a precompiled and closed manner which have the advantage that the simulator may be verified and validated, but in which there is no possibility of modifying the simulator, and in which the simulator functions as a “black box”. In these systems, no manner of failure testing is possible other than the situations envisaged by the vendor.

The aforementioned problems may be solved by the present invention. The present invention discloses a system and method for testing integrated or single process control systems, in which a signal simulator is introduced between one or more process simulators and the integrated process control system so that the signals transmitted between the simulators and the integrated process control system can be modified to simulate the effect of failures in the plant, or in sensors, computers, signal transmission and actuators. The present invention further discloses a system and method for testing the integrated control systems in which said control system outputs control signals to a series of interconnected “black box” simulators. It is also an object of the present invention to modify control signals from the integrated control system so as to be able to test the correct functioning of interacting simulators.

By using the hereby disclosed system and method it is possible to run extensive and detailed tests to determine if the integrated control and safety system will be capable of appropriately detecting and handling of failure situations in the petroleum process plant appropriately.

### BACKGROUND ART

Hardware-in-the-Loop Simulation for Unit Testing

The integrated control and safety system of a petroleum process plant may comprise several control systems and safety systems for the different subsystems of the petroleum plant. Presently, in unit testing of the control system, the control systems and the safety systems that comprise the integrated control system are tested individually one at the time.

According to background art, each individual control system is tested in unit testing by arranging the test subject control system in a hardware-in-the-loop simulation. In normal operation, the control system will output actuator signals that are transmitted to the actuators of the plant, and the control system will input sensor signals from the sensors in the plant. The control system includes at least one computer in which an algorithm calculates output signals to the actuators based on input signals from the sensors of the plant and input command signals from an operator. In hardware-in-the-loop testing the control system is disconnected from the plant, and is instead connected to a simulator, as illustrated in FIG. 2. In this arrangement the actuator signals that are output from the control system are transmitted to the simulator. The simulator will include at least one computer running an algorithm that calculates the sensor signals that would result from the real plant given appropriate initial conditions, and the actuator signals output from the test subject control system. The purpose of hardware-in-the-loop testing is to investigate if the plant subsystem performs satisfactorily, e.g., with sufficient accuracy, robustness and bandwidth, and if the specified functions of the control system conform to their functional descriptions when the plant subsystem is controlled by the control system. Moreover, hardware-in-the-loop testing can be used to check whether the control system is capable of detection and handling of failure situations appropriately when it shall control the plant subsystem.

An example of such a testing method is furnished by dSPACE GMBH (http://www.dspaceinc.com/shared/data/pdf/katalog2005/dspace_catalog2005_ecu-testing.pdf, as by 31. Sep. 2005), in which is described a system and method for testing ECU (electronic control units) mainly ECU units for ground vehicles like passenger cars and trucks. Different failure modes may be simulated, usually for integrity of an electric signal cable or broken or disconnected state of the cable, or the cable being grounded to zero ground or undesirably connected to full positive accumulator voltage, and the response of each separate ECU or integrated systems of ECUs is logged to assure the correct functioning of the control system or systems. However, this system requires that the simulator can be programmed to simulate the required failure situations. Furthermore in situations in which an operator desires to use different simulators like simulator subsystems for different portions of the process plant, there is no possibility of testing in which manner failure situations in one simulator subsystem of the simulator influences operating conditions in a different simulator subsystem of the complete simulator of the petroleum process plant. One example may be that one vendor may provide an excellent simulator for a 3-phase oil/water/gas separator subsystem, whereas another vendor may provide a good compressor simulator, and a third vendor may provide a simulator for a gas turbine, but none of the three vendors may have the required time or other resources or rights to integrate and recompile the three subsystem simulators for the process combining the use of the three subsystem simulators, and verification and validation of the subsystem simulators for the control system test only may be prohibitively expensive.

Safety Systems

A separate type of control systems comprise safety systems with input sensor signals and status signals from a plant subsystem and actuator signals and status signals from one or more control systems. The safety systems outputs logical control signals based on the input signals. Examples of logical control signals can be a signal to shut down a plant subsystem or the whole plant. Safety systems are usually tested using functional tests with an input signal generator. This involves inputting signals to the safety systems and observing if the logical output signals are according to specifications.

Integration Testing

According to background art, integration testing for an integrated control system for a petroleum process plant can be conducted with a hardware-in-the-loop simulator. In integration testing all control systems or a selection of control systems of the integrated control system are integrated or assembled for being tested. The integrated control systems outputs one or more actuator control signals to the simulator as a response to simulated sensor signals produced from the simulator. The simulator comprises one or more computers with one or more algorithms calculating the sensor signals that would result in the real plant given the control signals and under the predefined initial conditions. In addition, one or more safety systems may be included in an integration test to test the ability to conduct appropriate safety shut-downs of the process. The simulator will calculate the sensor signals and status signals to be input to the safety systems, while the safety systems outputs logical signals that are transmitted to the control systems or directly to the process to be controlled. An integration test is more complicated to run than a unit test because the simulator will have more inputs and outputs than in a unit test, and the algorithms that have to be run are more complicated.

Generic large scale simulation systems are available that can simulate a complete petroleum process plant, and that can be used for hardware-in-the-loop testing. Moreover such generic large scale simulation systems may include the possibility to conduct failure testing where the capability of the control systems to detect and handle failures in the petroleum plant can be investigated, and in which the functioning of the safety systems can be tested. An example of such a system has been provided by the industrial company Kongsberg Gruppen with their ASSETT® simulator.

However, it may be desirable for a petroleum plant company to use specialized simulators for the various parts of the petroleum process plants. Such simulation systems may be developed by different design teams specializing on particular types of process units and collections of process units in a plant, and it may be that such specialized simulators will be deemed to be more accurate or to provide more functions than a generic large scale simulation system. Thus, it may be desired for the petroleum plant company to be able to decide which simulators to use for the individual parts of the petroleum plant in integration tests using hardware-in-the-loop simulations. Traditionally such solutions have been used where integrated control systems have been integration tested using a collection of different simulators for the different parts of the petroleum plant. However, a serious drawback for such systems is, that it may not be feasible to run extensive failure tests. An example of such a situation would be if a compressor manufacturer furnishes a highly detailed and well-functioning simulator for a compressor and a different vendor provides an equally well-designed simulator for a power management system, and the two simulators, which are not designed to interconnect or are unable to exchange information, a simulation of the entire compressor/power management system may not be feasible.

Thus a signal modifying computer may be used to impose failure or unfavourable situations on the simulated systems, where said failure situations have not been envisaged by the vendor, or in situations in which the interconnection of several different simulators renders the imposition of failure situations impossible. By using the system and method according to the present invention, a much broader range of failure situations may be tested for, and a wider range of control systems or integrated control systems may be tested.

### SHORT SUMMARY OF THE INVENTION

The abovementioned problems may be overcome by using a method according to the present invention said method for testing whether a control system is capable of detection and handling of faults, failures, or failure modes in a petroleum process plant, said control system arranged for being

connected with input signal lines for receiving sensor and other input signals from said petroleum process plant, and

connected with control signals lines for transmitting control signals to said petroleum process plant,

Said method comprising the following steps:

a) connecting said control system using said input signal line for receiving simulated sensor or other input signals from a simulated petroleum process plant, and

b) connecting said control system using said control signal line for transmitting control signals to said simulated petroleum process plant, said method characterised in

c) connecting an input signal modifier to said input signal line, said input signal modifier modifying one or more of said input signals for transmitting one or more modified input signals and remaining non-modified input signals to said control system. Further steps of the method as defined by the present invention are defined in the attached dependent claims.

The invention further comprises a system arranged for testing whether a control system is capable of detection and handling of faults, failures or failure modes in a petroleum process plant. Said control system is arranged for being

connected with input signal lines for receiving sensor and other input signals from said petroleum process plant, and

connected with control signals lines for transmitting control signals to said petroleum process plant,

comprising the following features

said control system arranged for receiving simulated sensor signals or other input signals from a simulated petroleum process plant over said input signal line,

said control system further arranged for transmitting control signals to said petroleum process plant over said control signal line.

Said system is characterised by

an input signal modifier arranged for being connected to said input signal line and said input signal modifier arranged for modifying one or more said input signals into modified input signals, said input signal modifier being arranged for transmitting one or more of said modified input signals and remaining non-modified input signals to said control system.

Further advantageous features of the invention are defined in the attached dependent claims.

Short Figure Captions.

The attached figures are intended for illustration purposes only, and shall not be construed to in any manner limit the scope of the invention, which shall only be limited by the attached claims.

FIG. 1 describes general background art in which an integrated control and safety system is connected to a petroleum process plant. The control and safety system is arranged for the safe operation of the process plant. In normal operation, the control system furnishes control signals to the process plant, and said process plant acts as a response said control signals, and further provides sensor signals indicating the status of the process variables. The petroleum process plant is subject to failures and disturbances such as sudden drops in pressure, changes in chemical composition of the process stream, slow or sudden changes in the input volumes of either fluids or solids, and other disturbances, mechanical component failure, surges in energy supply, undesired precipitation of wax or scale in pipes, leakages, and other disturbances.

FIG. 2 describes the same situation as FIG. 1 but in which the process plant is replaced by a simulated petroleum process plant, and where the simulated process plant and its initial thermodynamic state is arranged for as closely as possible to resemble the real petroleum process plant. The control signals furnished by the integrated control and safety system are furnished to the petroleum process plant simulator and the simulated petroleum process plant provides simulated sensor signals as a response to said control signals. The petroleum process plant simulator may be subject to simulated failures and disturbances like those mentioned above for the real plant, and may further comprise a failure testing module, in which various failure modes for the specific simulator may be simulated. Said simulated failure testing modules may allow testing of the said integrated control and safety systems capability to detect and handle failures in said petroleum process plant, and may also comprise the possibility for testing safety systems.

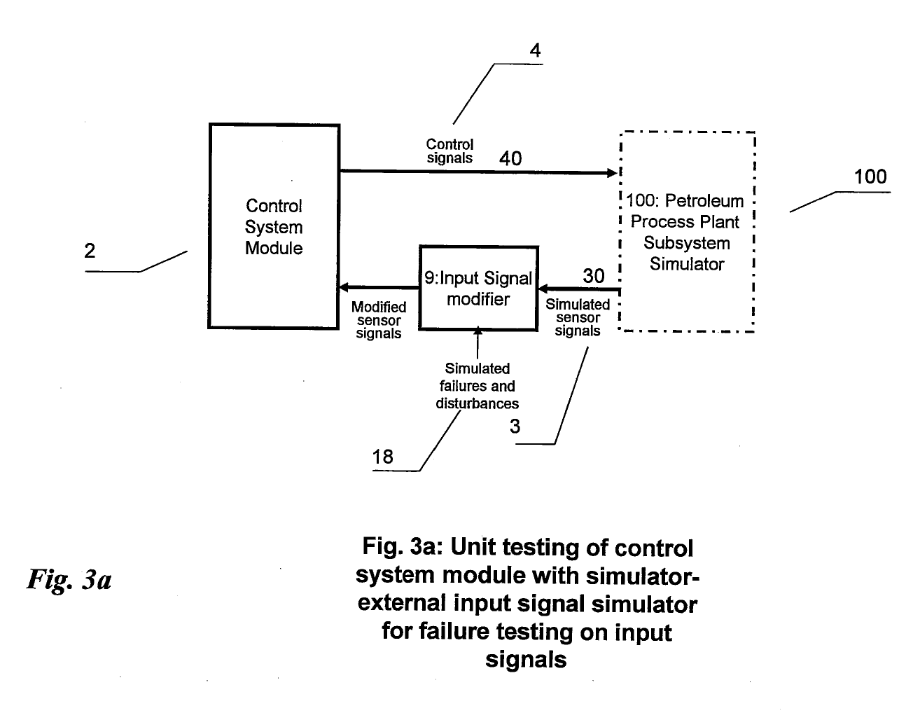

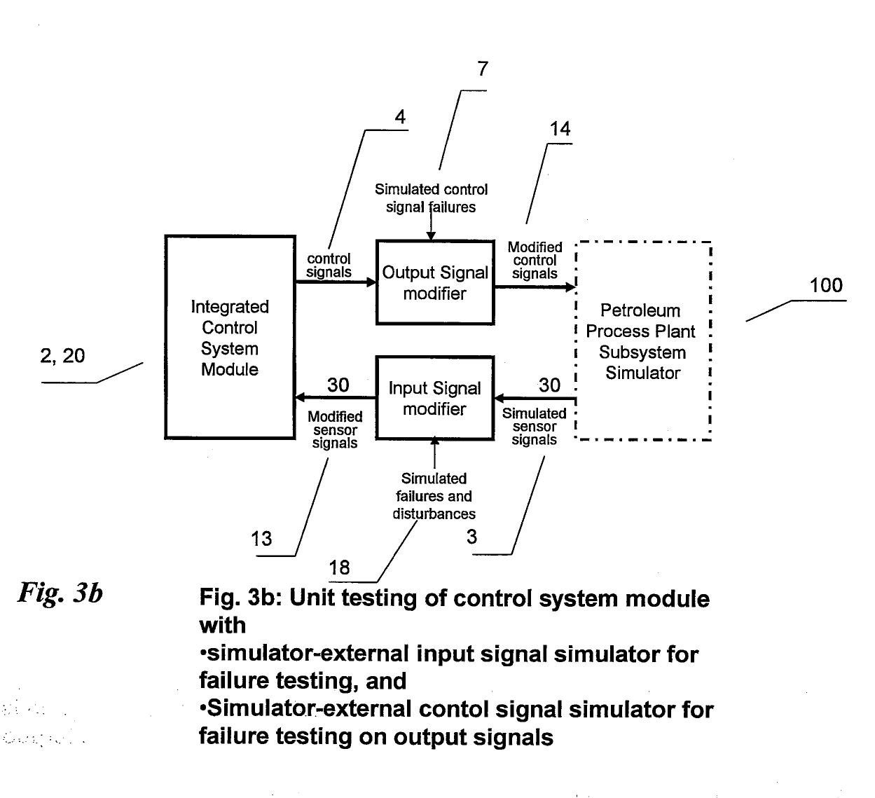

FIG. 3a illustrates an embodiment according to the invention in which an input signal modifier is arranged between a process plant subsystem simulator and a control system module. The input signal modifier is arranged for receiving the simulated sensor signals furnished by a petroleum process plant subsystem simulator and modifying some or all of said simulated sensor signals in order to simulate failures and disturbances that may occur in the petroleum process plant subsystem (or in the subsystem simulator). The modified sensor signals, as well as the unmodified sensor signals from the input signal modifier are transmitted to the control system module in order to test whether the control system module will provide an adequate and appropriate response to the modified signals and the remaining non-modified signals. This system allows for unit testing of control system modules with simulator-external input signal simulator for failure testing on input signals. A control system module may typically comprise control of a separate petroleum process unit as used in the present invention such as an oil, gas, water separator, or a compressor.

FIG. 3b broadly describes the same situation as in FIG. 3a, but, in which in addition to allowing modification of sensor signals from the petroleum process plant subsystem simulator, modification of the resulting control signals from the control system module is made possible. Thus control signals from the control system module are furnished to an output signal modifier in which some or all of said control signals are modified into modified control signals, and the modified signals as well as the remaining non-modified signals may be furnished to the petroleum process plant subsystem simulator, in order to verify the correct functioning of the control system module. An example of modifying a control signal may be a situation of which the control system provides redundant control signals to the same subprocess, and modifying one of the redundant signals may check whether the simulated process is capable of detecting and handling the conflicting differences in the redundant signals.

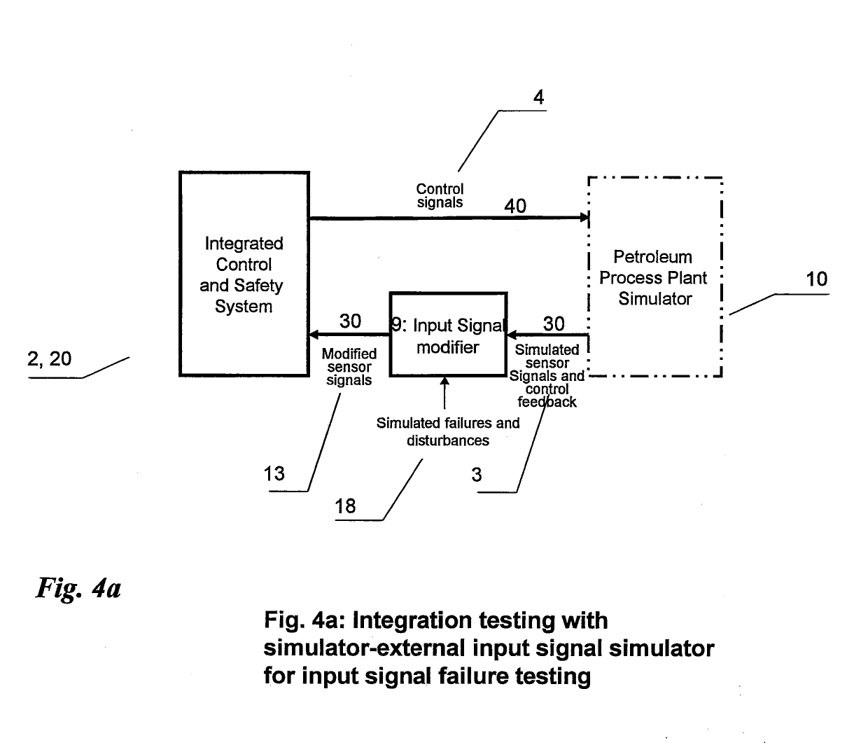

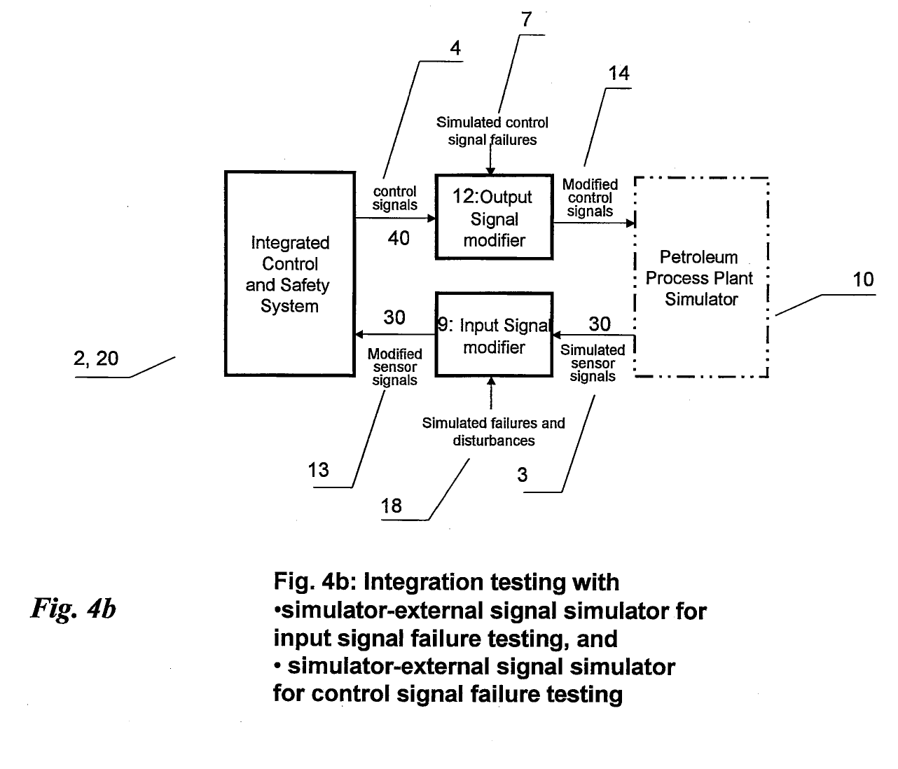

FIG. 4a is similar to FIG. 3a but in which the control system module is replaced by an integrated control and safety system in which said integrated control and safety system may comprise a number of redundant or different control system modules. In this embodiment of the present invention integration testing with simulator-external input signal modifier for simulated input signal failure or petroleum process plant failure testing is made possible.

FIG. 4b is broadly similar to FIG. 3b but in which the control system module is replaced by an integrated control and safety system in which said integrated control and safety system may comprise a large number of control system modules. Thus one may perform integration testing with a simulator-external signal modifier also for input signal failure testing or petroleum process plant failure testing, as above, and additionally a simulator-external signal modifier for control signal failure testing.

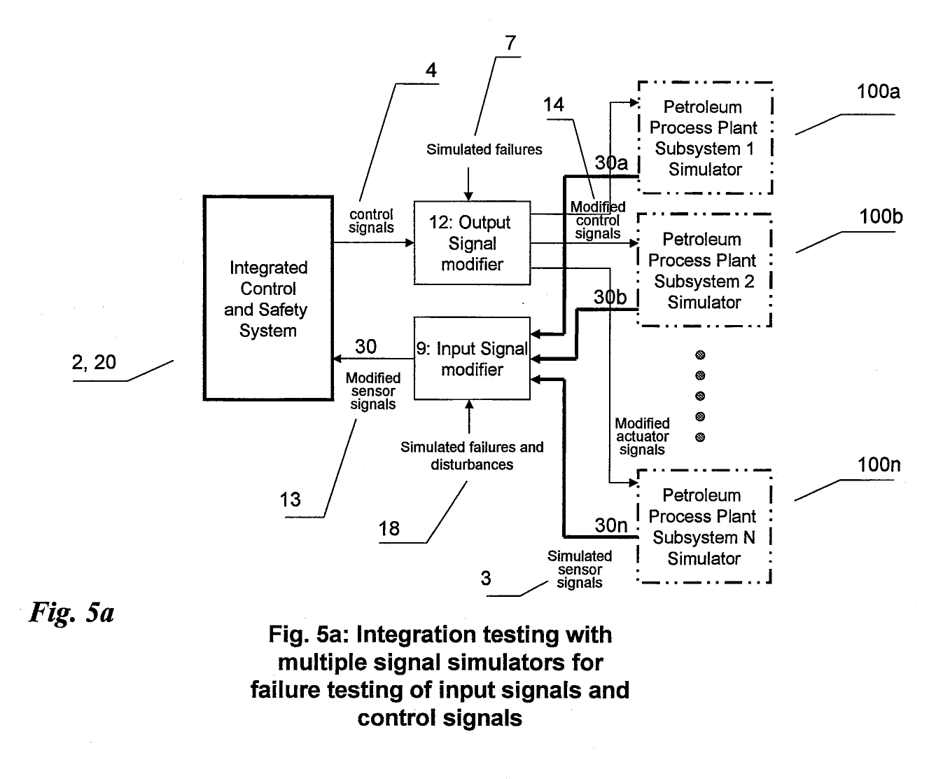

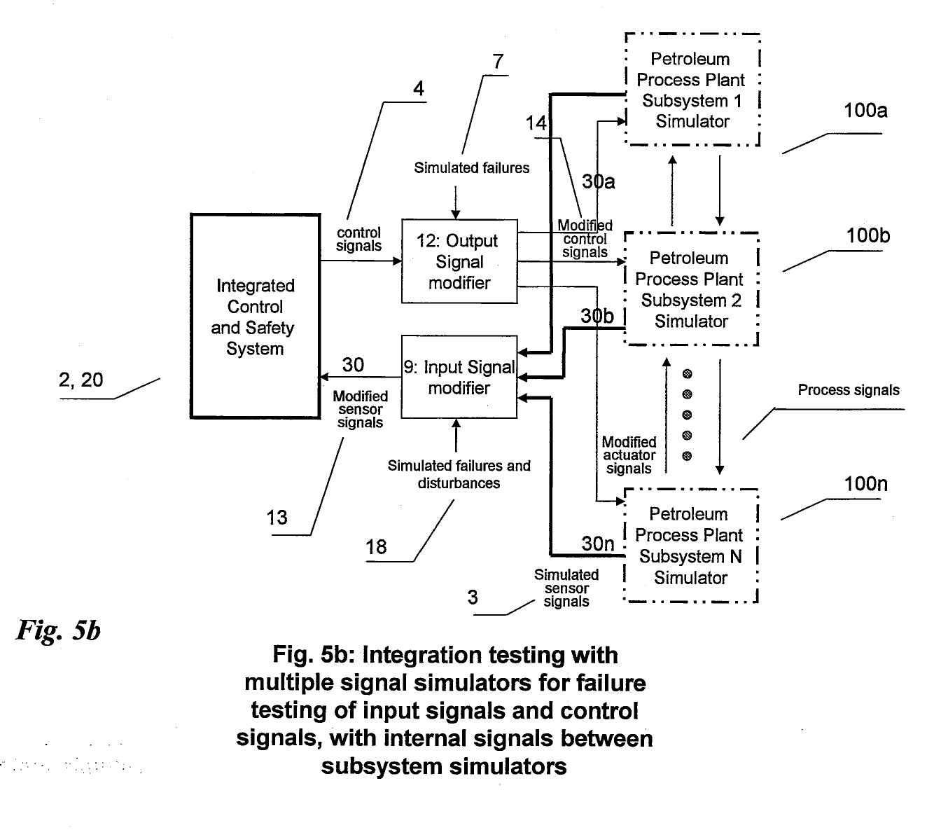

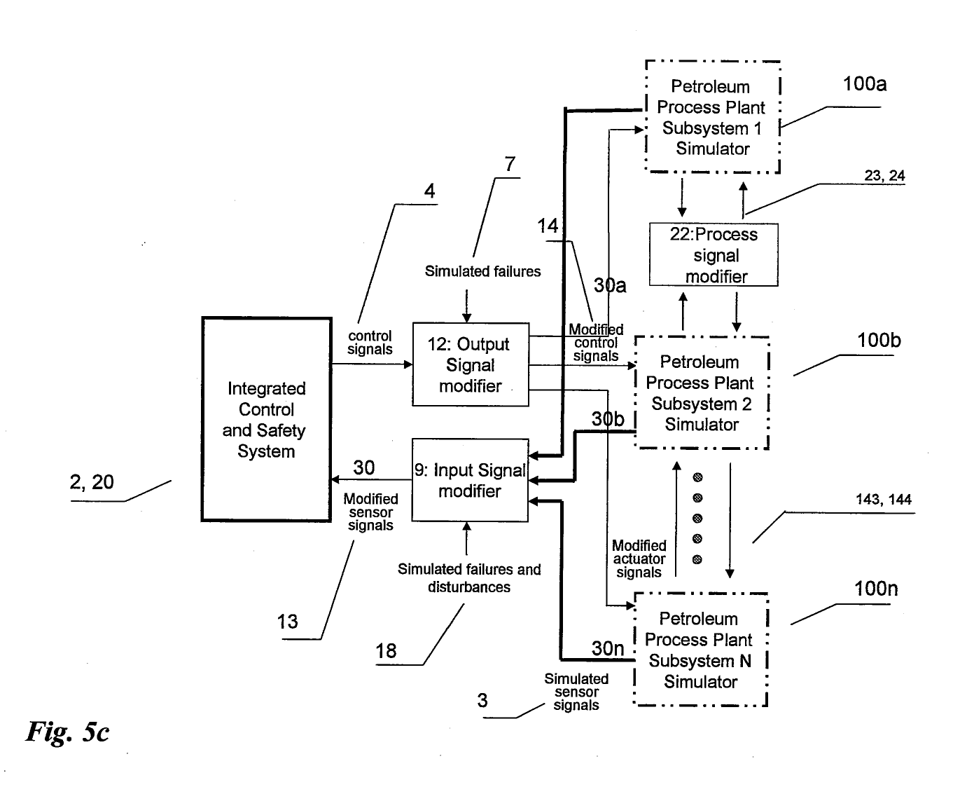

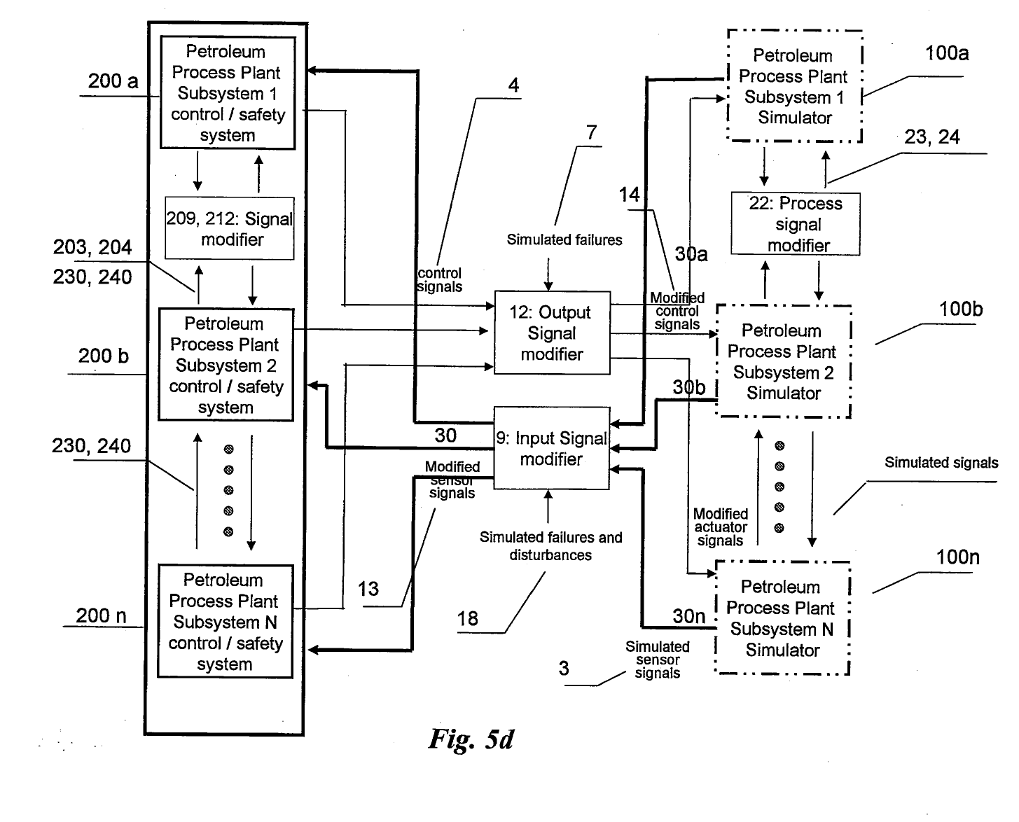

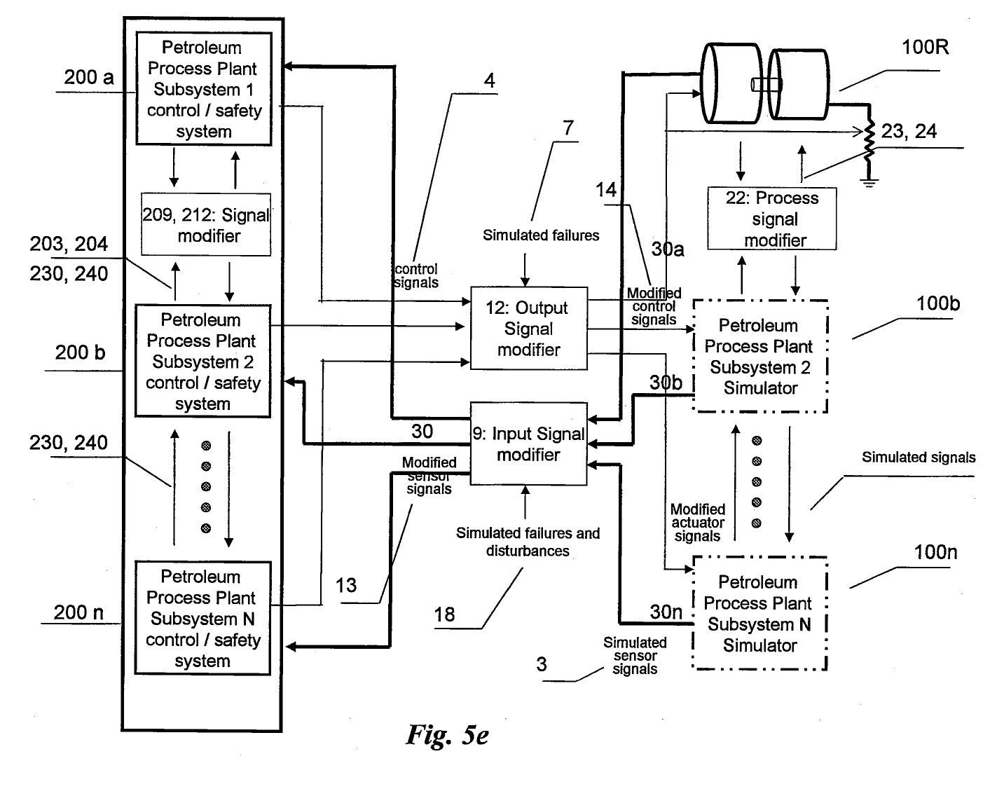

FIG. 5a illustrates a system in which several independent process plant subsystem simulators independently transmit simulated sensor signals to an input signal modifier, and in which said input signal modifier modifies some or all of said simulated sensor signals and furnishes said modified and remaining unmodified sensor signals to an integrated control and safety system. The signals are modified so as for enabling simulation of failures and disturbances in the subsystems or in the transmission line. As a response to said modified and remaining unmodified sensor signals said integrated control and safety system furnishes control systems to each of said process plant subsystems. Additionally some or all of said control signals may also be modified by an output signal modifier. The modified control signals are modified so as for enabling simulation of failures in the control signal line or for discovering problems in discriminating between conflicting differences between redundant commands, or conflicting states or values of control signals provided from the control system, or such conflicting values arising from undesired transmission effects. The illustrated system allows for integration testing with multiple signal modifiers for failure testing of input signals and control signals.

FIG. 5b resembles FIG. 5a, in which, in addition to the features described in FIG. 5a, is described modification of signals passing from one petroleum process plant subsystem to another without said signals necessarily being transmitted to the integrated control and safety system may be modified by a signal modifier, in order to test the correct functioning of the control system when there are errors in the mutual internal transmission of signals e.g. control signals or status signals between the petroleum process plant subsystem simulators.

FIG. 5c resembles FIG. 5b, in which in addition to the features described in FIG. 5b, is described modification of signals passing directly from one process plant subsystem simulator to another separate process plant subsystem simulator.

FIG. 5d resembles FIG. 5c, in which, in addition to the features described in FIG. 5c, is described modification of signals passing from one process plant subsystem control system to a second separate process plant subsystem control system. The separate process plant subsystem control system may in conjunction form an integrated control and safety system, in which e.g. an emergency shutdown system is included in the control system.

FIG. 5e is like FIG. 5d, but showing a hybrid system combining real components, here a power system being integrated to run simultaneously with the remaining subsystem simulators, and receiving control signals indicating the instantaneous power demand commanded from the subsystem simulators. The power system may be provided with a controlled variable resistive load to emulate the consumed power commanded by the simulated subsystems, i.e. simulated compressors, simulated pumps, simulated separators.

FIG. 6a illustrates an integrated platform, sub-sea and land plant system arranged for the processing of process streams from oil and/or gas wells, in which said integrated system is controlled by an integrated operations control system. One part of the system, e.g. the subsea petroleum process plant, may receive a petroleum stream directly from upstream in a petroleum production well, and may conduct a simple separation of oil, gas and water for eporting the gas via a pipeline to a land petroleum process plant, and for exporting the separated oil under intermediate pressure to a combined petroleum production and process plant platform nearby, for including the intermediate pressure oil from the subsea well in later stages of petroleum processing after a high-pressure petroleum separation of the platform's own high-pressure wellstream.

FIG. 6b describes an integration testing of a platform, sub-sea and land plant control system for corresponding platform, subsea and land petroleum process plants, in which the separate integrated control systems, which may be situated considerable distances from each other, are controlled by a separate integrated operations control system, and in which superior monitoring input and superior monitoring control signals for one or more of said integrated control system may be modified in a similar manner as described above for the production plant control systems.

### PREFERRED EMBODIMENTS OF THE INVENTION

The invention is a method and a system for testing whether a control system (2) is capable of detection and handling of faults, failures, or failure modes (8) in a petroleum process plant (1). The control system (2) is arranged for being connected with input signal lines (30) for receiving sensor and other input signals (3r) from said petroleum process plant (1), and connected with control signals lines (40) for transmitting control signals (4) to said petroleum process plant (1). The method according to the invention comprises the following steps:

a) connecting said control system (2) using said input signal line (30) for receiving simulated sensor or other input signals (3s) from a simulated petroleum process plant (10), and

b) connecting said control system (2) using said control signal line (40) for transmitting control signals (4) to said simulated petroleum process plant (10), and the characterising part of the invention is the following step:

c) connecting an input signal modifier (9) to said input signal line (30), said input signal modifier (9) modifying one or more of said input signals (3) for transmitting one or more modified input signals (13) and remaining non-modified input signals (3) to said control system (2). This allows modifying sensor signals (3) and other signals provided by the simulated petroleum process (10) thus providing means to introduce errors which are likely to occur in the real petroleum process plant (1), but not easily implemented in the petroleum process simulator (10) due to various reasons described in the introductory part of this patent specification. This advantage is obvious if several petroleum subprocess simulators (100) provided from multiple vendors or sources are required to simulate the entire petroleum process (1). Further advantages of the invention will be explained below.

In one embodiment of the invention, the method comprises connecting an output or control signal modifier (12) to said output control line (30). The output control signal modifier (12) modifies one or more of said control signals (4) to modified control signals (14), and transmits these modified control signals (14) and remaining non-modified control signals (4) to said simulated petroleum process plant (1). In this manner, actually the simulator is tested for its capability to handle some errors induced by the control system sending erroneous control signals, e.g. discrepancy between redundant control signals supposed to be generally equal in numerical value or voltage, but of which one has become disturbed. This may alternatively be used for “benchmarking” the accuracy and robustness of simulators of different make and model.

The system according to the invention may comprise input signal lines (30) and control signal lines (40) being one or more of fixed signal lines such as Ethernet or RS442, RS232, analogue lines, digital lines, optical lines, or wireless communication lines, and in which the signals are transmitted according to one or more communication protocols such as Field bus protocols, CAN-bus protocols, Field bus foundation protocols, vendor proprietary bus protocols, Bluetooth protocols.

In a preferred embodiment of the system according to the invention, the control system (2) comprises one or more safety systems (20) arranged for commanding shutting down of the simulated petroleum process plant (10).

Interacting Simulated Plant Subprocesses

The method according to the invention may comprise interaction between two or more interacting petroleum plant subprocess simulators (100) within said petroleum process plant (10) simulators. Two or more of these petroleum plant subprocess simulators (100) may mutually transmit simulated measurement signals (23) representing mass, temperature T, pressure P, momentum, density, composition or other state parameters, or energy transfer. As an example, one simulated subprocess may be an oil/gas/water separator having dynamically calculated outflux of oil volume, density, temperature, composition and pressure, gas volume, density, temperature, composition and pressure, and water volume, temperature and purity. These calculated parameters shall be forwarded to subprocess simulators for simulated receipt of the above products like a compressor simulator for the simulated gas volume, and another separator simulator for the calculated oil volume. The processes may also interact using simulated control signals (24) (state variables, logical states like shut or open valves, or function modes) on signal lines (143, 144).

In a preferred embodiment of the invention the method comprises a process signal modifier (22) modifying said simulated measurement signals (23) or said control signals (24) between said petroleum plant subprocesses simulators (100). In this way one may simulate introducing errors likely to occur between components of the real petroleum processing plant (1), like leakages in a pipe or a valve, incurring that the volume or pressure out of one subprocess is not the same as the volume or pressure for the fluid arriving at the downstream subprocess. These errors are not likely to be implemented in subprocess simulators, but are nevertheless important to test for.

According to a preferred embodiment of the invention, the method comprises that an input signal modifier (9) modifies one or more of said input signals (3) for forming one or more modified input signals (13) based on mathematical models of said plant (1). These mathematical models are based on physical laws including thermodynamic theory, comprising continuous variables and/or boolean variables. The simulated failures and disturbances (18) input by the input signal modifier (9) may be based on physical processes in the plant (1) and possible errors and disturbances on said signal transmission line (30).

The simulated failures and disturbances input by the input signal modifier (9) may be predefined or defined by an operator according to the operators desire, or automatically generated or defined by a historically recorded incident.

The method according to the invention may constitute using a hybrid system combining simulated subprocesses that are easily simulated, and integrate real petroleum plant subprocesses (100R), such as an electrical generator or other power supply systems that may have an simulated, real electrical load. The electrical generator may have rapidly fluctuating voltage transients that are difficultly modeled, and may be more realistically included in the test in their physical implementation. Alternatively, one may conduct a test including testing the appropriate action of real valves, actuators, hydraulics, sensors etc. in the simulation process with simulated petroleum plant subprocesses (100). In this way the method according to the invention may act as a FAT (factory acceptance test)/CAT (customer acceptance test) test for components within a process system being assembled, but before any fluids are contained within the system.

Failure Modes

In a further preferred embodiment of the invention said modifying of input signals (3) or said output signals (4) is based on failure modes, in which said failure modes may be functional manifestations of failures, in which said failures may be the inability of components to perform their function due to faults, in which said faults may be defects in said components. Thus the physical manifestation of defects in the components as well as their results may be simulated and tested for. In an embodiment of the invention one or more of the following signal modifications to said input signals (3) to form modified input signals (13) may be introduced

miscalibrated input signals,

out of range input signals,

disturbances on input signals,

replacing input signals,

interchanging input signals,

removing or missing input signals,

delayed input signals,

locked valve or locked valve signal,

stuck component or stuck component signal,

missing (oil, energy, water, . . . ) supply or signal indicating missing supply,

missing pressure or signal indicating missing pressure

redundant sensors showing conflicting measurements.

other failures, or failures resulting from faults.

Thus different faults and their corresponding failures may be simulated and tested for.

Control Subsystems

In another embodiment of the invention, said control system (2) may comprise two or more control subsystems (200a, 200b, . . . , 200m) controlling petroleum process plant subsystems or corresponding simulators (100a, 100b, . . . , 100n). The two or more control subsystems (200) may be mutually connected by signal lines (230, 240) transmitting measurement signals (203) and/or control signals (204) between said control subsystems (200a, 200b, . . . ). In a preferred embodiment of the invention, signal modifiers (209, 212) are connected on said signal lines (230, 240) between said control subsystems (200a, 200b, . . . ), and the signal modifiers (209, 212) may modify said measurement signals (203) and/or control signals (204) running between said control subsystems (200a, 200b).

Realistic Process Simulation

In a particularity preferred embodiment of the invention said petroleum plant subsystem simulators (100a, 100b, . . . , 100n) may represent one or more of the following real processes:

receiving petroleum fluid under pressure from one or more wells via a production manifold

separating said petroleum fluid under pressure into liquid oil, water, gas and possibly sand,

Oil Processing:

cooling said oil,

storing said oil on tanks or exporting said oil to ships or via pipelines,

Gas Processing:

compressing said gas and/or cooling said gas

flaring off parts of said gas,

exporting said gas using pipelines or ships,

reinjecting parts of said gas,

producing electrical energy using gas turbines running electrical generators possibly controlled by power management systems.

Water Processing:

purifying said water for dumping

reinjecting or dumping said water

as well as other possible process operations performed within a petroleum process plant (1).

Integrated Operations Control System

In an preferred embodiment of the invention two or more process plant control systems (2a, 2b, 2c, . . . ) are connected, each process plant control system (2a, 2b, 2c, . . . ) controlling one or more petroleum process plants (1a, 1b, 1c, . . . ) being one or more of an offshore platform process plant (1a), a subsea process plant (1b) or optionally a land petroleum process plant (1c), to an integrated operations control system (50). The connection is made by using input signal lines (60a, 60b, 60c, . . . ) from the control system (2a, 2b, 2c, . . . ) said input signal lines (60a, 60b, 60c, . . . ) respectively inputting monitoring signals (63) from plant control systems (2a, 2b, 2c, . . . ) to said integrated operations control system (50), and using control signal lines (70) for transmitting output monitoring signals (73) from said integrated operations control system (50) to said process plant control systems (2a, 2b, 2c, . . . ). This control superstructure is common in systems which are controlled by an integrated operations system (50) in which a command center in real-time controls the operation of multiple petroleum processing plants (1), where the petroleum processing plants may be situated a long distance away from each other as well as being situated a long distance from the command center. Subsea systems are also remotely controlled, and it is therefore important to be able to test the integrated operations control systems (50) for errors imagined to occur in the remote controlling of multiple petroleum process plants (10) but which would be costly or dangerous to directly test for. Thus in a preferred embodiment of the invention one may arrange one or more input signal modifiers (39) on said input signal lines (60a, 60b, 60c, . . . ) between said plant control systems (2a, 2b, 2c, . . . ) and said integrated operations control system (50). The input signal modifiers (39) may modify one or more of the monitoring signals (63) and input said one or more modified monitoring signals (64) and remaining unmodified monitoring signals (63) into said plant control systems (2a, 2b, 2c, . . . ). In a further preferred embodiment of the invention, one or more control signal modifiers (32) are arranged on said monitoring output signal lines (70a, 70b, 70c, . . . ) from said integrated operations control system (50) to said plant control systems (2a, 2b, 2c, . . . ). The monitoring output signal modifiers (39) modify one or more of said output monitoring signals (73) into modified monitoring output signals (74) and inputting said one or more modified monitoring output signals (74) and remaining unmodified monitoring output signals (73) into said plant control systems (2a, 2b, 2c, . . . ).

The integrated operations control system (50) may typically be remotely located, e.g. on a remote platform or on-shore, and the monitoring signals (63) from the control systems (2) transmitted to the integrated operations system (50) may comprise status signals, measurement signals (3) and control signals (4).

Tuition

In an advantageous embodiment of the invention, the described method may be used for setting up test scenarios comprising initial physical and chemical conditions, input command settings, status signals, and possible sequences of one or more defects and associated failures, for training control system operators for commanding said control system (2) controlling said simulated petroleum process plant (10). Thus control system operators may be trained in the handling of difficult situations which may be imagined to occur when controlling a petroleum process plant (1), or an integrated operations control system controlling multiple process plants (1). As the present invention allows for the integration of different simulators from different vendors into a complex simulation of a petroleum process plant, an as accurate as possible simulation of the system may be simulated, and thus an efficient training of operators achieved.

HIL Interfacing Alternatives

There are different manners in which the signal modifiers may be connected to the systems and subsystems in which signals need to be modified. For an integrated control system, the signal modifier can be interfaced in-the-loop between the control computer system and the real plant. The appropriate signals can then be manipulated while they are passing through the signal modifier, while the rest of the signals are bypassed. An alternative if there exists a signal test I/O interface, is to connect the signal modifier to the test I/O. The real feedback signals are then rerouted via the signal I/O to the test I/O, sent to the signal modifier for signal failure mode manipulation, and then returned for processing in the control kernel via the test I/O.

What is claimed is:

1. A method for testing whether a control system (2) is capable of handling faults,
failures, or failure modes (8) in a petroleum process plant (1), said control system (2) arranged for being
connected with input signal lines (30) for receiving sensor and other input signals (3r) from said petroleum process plant (1), and
connected with control signals lines (40) for transmitting control signals (4) to said petroleum process plant (1),
comprising the following steps:
a) connecting said control system (2) using said input signal line (30) for receiving simulated sensor or other input signals (3s) from a simulated petroleum process plant (10), and
b) connecting said control system (2) using said control signal line (40) for transmitting control signals (4) to said simulated petroleum process plant (10),
characterised in
c) connecting an input signal modifier (9) to said input signal line (30), said input signal modifier (9) modifying one or more of said input signals (3) for transmitting one or more modified input signals (13) and remaining non-modified input signals (3) to said control system (2).

2. The method of claim 1, connecting an output or control signal modifier (12) to said output control line (30), said output control signal modifier (12) modifying one or more of said control signals (4) to modified control signals (14) and transmitting said modified control signals (14) and remaining non-modified control signals (4) to said simulated petroleum process plant (1).

3. The method of claim 1, comprising interaction between two or more interacting petroleum plant subprocess simulators (100) within said petroleum process plant (10) simulators.

4. The method of claim 3, in which two or more of said petroleum plant subprocess simulators (100) mutually transmit simulated measurement signals (23) representing mass (T, P, momentum, density, composition or other state parameters) or energy transfer, or simulated control signals (24) (state variables, logical states like shut or open valves, or function modes) on signal lines (143, 144).

5. The method of claim 4, comprising a process signal modifier (22) modifying said simulated measurement signals (23) or said control signals (24) between said petroleum plant subprocesses simulators (100).

6. The method of claim 1, said input signal modifier (9) modifying one or more of said input signals (3) for forming one or more modified input signals (13) based on mathematical models of said plant (1).

7. The method of claim 6, said mathematical models based on physical laws including thermodynamic theory, comprising continuous variables and/or boolean variables.

8. The method of claim 1, said simulated failures and disturbances (18) input by said input signal modifier (9) being based on physical processes in said plant (1) and possible errors and disturbances on said signal transmission line (30).

9. The method claim 8, in which said simulated failures and disturbances input by said input signal modifier (9) being predefined or defined by an operator according to said operator's desire or automatically generated or defined by a historically recorded incident.

10. The method of claim 3, integrating real petroleum plant subprocesses (100R) (such as an electrical generator or other power supply systems with an electrical load rapid transients difficultly modeled, such as FAT/CAT test within a process system being assembled, but before any fluids are contained within the system, and in which one wishes to test the appropriate action of valves, actuators, hydraulics, sensors etc etc.) in the simulation process with simulated petroleum plant subprocesses (100).

11. The method of claim 1, said modifying of input signals (3) or said output signals (4) based on failure modes, in which said failure modes being functional manifestations of failures, in which said failures being the inability of components to perform their function due to faults, in which said faults being defects in said components.

12. The method of claim 11, introducing one or more of the following signal modifications to said input signals (3) to form modified input signals (13), said failures comprising one or more of:
miscalibrated input signals,
out of range input signals,
disturbances on input signals,
replacing input signals,
interchanging input signals,
removing or missing input signals,
delayed input signals,
locked valve or locked valve signal,
stuck component or stuck component signal,
missing (oil, energy, water, . . . ) supply or signal indicating missing supply,
missing pressure or signal indicating missing pressure
redundant sensors showing conflicting measurements.

13. The method of claim 1, said control system (2) comprising two or more control subsystems (200a, 200b, . . . , 200m) controlling petroleum process plant subsystems or corresponding simulators (100a, 100b, . . . , 100n).

14. The method of claim 13, said two or more control subsystems (200) mutually connected by signal lines (230, 240) transmitting measurement signals (203) and/or control signals (204) between said control subsystems (200a, 200b, . . . ).

15. The method of claim 14, comprising connecting signal modifiers (209, 212) on said signal lines (230, 240) between said control subsystems (200a, 200b, . . . ) modifying said measurement signals (203) and/or control signals (204) running between said control subsystems (200a, 200b).

16. The method of claim 1, said petroleum plant subsystem simulators (100a, 100b, . . . , 100n) representing one or more of the following real processes:
receiving petroleum fluid under pressure from one or more wells via a production manifold
separating said petroleum fluid under pressure into liquid oil, water, gas and possibly sand,
cooling said oil,
storing said oil on tanks or exporting said oil to ships or via pipelines,
compressing said gas and/or cooling said gas
flaring off parts of said gas,
exporting said gas using pipelines or ships,
reinjecting parts of said gas,
producing electrical energy using gas turbines running electrical generators possibly controlled by power management systems.
purifying said water for dumping
reinjecting or dumping said water.

17. The method of claim 1, connecting two or more process plant control systems (2a, 2b, 2c, . . . ), each process plant control system (2a, 2b, 2c, . . . ) controlling one or more petroleum process plants (1a, 1b, 1c, . . . ) being one or more of an offshore platform process plant (1a), a subsea process plant (1b), and optionally a land petroleum process plant (1c), to an integrated operations control system (50) using input signal lines (60a, 60b, 60c . . . ) from said control system (2a, 2b, 2c, . . . ) said input signal lines (60a, 60b, 60c . . . ) respectively inputting monitoring signals (63) from plant control systems (2a, 2b, 2c, . . . ) to said integrated operations control system (50), and using control signal lines (70) for transmitting superior control signals (73) from said integrated operations system (50) to said process plant control systems (2a, 2b, 2c, . . . ).

18. The method of claim 17, arranging one or more input signal modifiers (39) on said input signal lines (60a, 60b, 60c, . . . ) between said plant control systems (2a, 2b, 2c, . . . ) and said integrated operations control system (50), said input signal modifiers (39) modifying one or more of said monitoring signals (63) and inputting said one or more modified monitoring signals (64) and remaining unmodified monitoring signals (63) into said plant control systems (2a, 2b, 2c, . . . ).

19. The method of claim 17, arranging one or more control signal modifiers (32) on said monitoring output signal lines (70a, 70b, 70c, . . . ) from said integrated operations control system (50) to said plant control systems (2a, 2b, 2c, . . . ), said monitoring output signal modifiers (39) modifying one or more of said output monitoring signals (73) into modified monitoring output signals (74) and inputting said one or more modified monitoring signals (74) and remaining unmodified monitoring output signals (73) into said plant control systems (2a, 2b, 2c, . . . ).

20. The method of claim 17, said integrated operations system (50) being remotely located, e.g. on a remote platform or on-shore.

21. The method of claim 17, said monitoring signals (63) from said control systems (2) comprising status signals, measurement signals (3) and control signals (4).

22. The method according to claim 1, setting up test scenarios for said simulators comprising initial physical and chemical conditions, input command settings, status signals, and possible sequences of one or more defects and associated failures, for training control system operators for commanding said control system (2) controlling said simulated petroleum process plant (10).

23. A system for testing whether a control system (2) is capable of detection and handling of faults, failures or failure modes (8) in a petroleum process plant (1), said control system (2) arranged for being
connected with input signal lines (30) for receiving sensor and other input signals (30) from said petroleum process plant (1), and
connected with control signals lines (40) for transmitting control signals (4) to said petroleum process plant (1),
comprising the following features
said control system (2) arranged for receiving simulated sensor signals or other input signals (3s) from a simulated petroleum process plant (10) over said input signal line (30),
said control system (2) arranged for transmitting control signals (4) to said petroleum process plant simulator (10) over said control signal line (40), characterised by
an input signal modifier (9) arranged for being connected to said input signal line (30),
said input signal modifier (9) arranged for modifying one or more said input signals (3) into modified input signals (13),
said input signal modifier (9) being arranged for transmitting one or more of said modified input signals (13) and remaining non-modified input signals (3) to said control system (2).

24. The system according to claim 23, said input signal lines (30) and said control signal lines (40) being one or more of fixed signal lines such as Ethernet or RS442, RS232, analogue lines, digital lines, optical lines, or wireless communication lines, and in which the signals are transmitted according to one or more communication protocols such as Field bus protocols, CAN-bus protocols, Field bus foundation protocols, proprietary bus protocols, Bluetooth protocols.

25. The system according to claim 23, comprising an output signal modifier (12) arranged for being connected to said output control line (30), in which said output signal modifier (12) is arranged for modifying one or more of said control signals (4) to modified control signals (14), and is further arranged for transmitting said modified control signals and remaining non-modified control signals (3) to said simulated petroleum process plant (10).

26. The system according to claim 23, said control system (2) comprising one or more safety systems (20) arranged for commanding shutting down of the simulated petroleum process plant (10).

27. The system according to claim 23, said simulated petroleum process plant (10) comprising two or more interacting simulated petroleum subprocess (100).

28. The system according to claim 27, said two or more simulated petroleum subprocesses (100) arranged for mutually transmitting simulated measurement signals (23) representing mass, temperature, pressure, momentum, density, composition or other state parameters or energy transfer, or simulated state variables (24), continuous states, variables, logical states like shut or open valves, or function modes on signal lines (143, 144).

29. The system according to claim 27, comprising a process signal modifier (22) being arranged for modifying said simulated measurement signals (23) or said states or control signals (24) between simulated petroleum plant subprocesses (100).

30. The system of claim 27, comprising real petroleum plant subprocesses (100R) (such as an electrical generator or other power supply systems with an electrical load rapid transients difficultly modeled, such as FAT/CAT test within a process system being assembled, but before any fluids are contained within the system, and in which one wishes to test the appropriate action of valves, actuators, hydraulics, sensors etc etc.) in the simulation process with simulated petroleum plant subprocesses (100).

31. The system of claim 23, said control system (2) comprising two or more control subsystems (200a, 200b, . . . , 200m) arranged for controlling petroleum process plant subsystems or corresponding simulators (100a, 100b, . . . , 100n).

32. The system of claim 31, said two or more control subsystems (200) mutually connected by signal lines (230, 240) arranged for transmitting measurement signals (203) and/or control signals (204) between said control subsystems (200a, 200b, . . . ).

33. The system of claim 32, comprising signal modifiers (209, 212) arranged for being connected on said signal lines (230, 240) between said control subsystems (200a, 200b, . . . ) arranged for modifying said measurement signals (203) and/or control signals (204) running between said control subsystems (200a, 200b).

34. The system according to claim 23, comprising two or more process plant control systems (2a, 2b, 2c, . . . ), each process plant control system (2a, 2b, 2c, . . . ) arranged for controlling one or more petroleum process plants (1a, 1b, 1c . . . ) being one or more of a offshore platform process plant (1a), a subsea process plant (1b), and optionally a land petroleum process plant (1c), to an integrated operations control system (50) using input signal lines (60a, 60b, 60c . . . ) from control system (2a, 2b, 2c, . . . ) said input signal lines (60a, 60b, 60c . . . ) respectively arranged for inputting monitoring signals (63) from plant control systems (2a, 2b, 2c, . . . ) to said integrated operations system (50), and using control signal lines (70) arranged for transmitting superior control signals (73) from said integrated operations system (50) to said process plant control systems (2a, 2b, 2c, . . . ).

35. The system according to claim 34, comprising input signal modifiers (39) arranged for being connected on said input signal lines (60a, 60b, 60c, . . . ) from said plant control systems (2a, 2b, 2c, . . . ) and said integrated operations control system (50), said input signal modifiers (39) arranged for modifying one or more of said monitoring signals (63) and inputting said one or more modified monitoring signals (64) and remaining unmodified monitoring signals (63) into said plant control systems (2a, 2b, 2c, . . . ).

36. The system of claim 34, comprising one or more control signal modifiers (32) on said monitoring output signal lines (70a, 70b, 70c, . . . ) from said integrated operations control system (50) to said plant control systems (2a, 2b, 2c, . . . ), said monitoring output signal modifiers (39) arranged for modifying one or more of said output monitoring signals (73) into modified monitoring output signals (74) and arranged for inputting said one or more modified monitoring signals (74) and remaining unmodified monitoring output signals (73) into said plant control systems (2a, 2b, 2c, . . . ).

37. The system according to claim 34, said integrated operations system (50) being remotely located, e.g. on a remote platform or remotely situated on-shore.
